(19) United States
(12) Patent Application Publication
(10) Pub. No.: US 2025/0070206 A1
(43) Pub. Date: Feb. 27, 2025

(54) COOLING STRUCTURE FOR AN AIR COOLER

(71) Applicants: HYUNDAI MOTOR COMPANY, Seoul (KR); KIA CORPORATION, Seoul (KR)

(72) Inventor: Oh Tak Kwon, Yongin-si (KR)

(73) Assignees: HYUNDAI MOTOR COMPANY, Seoul (KR); KIA CORPORATION, Seoul (KR)

(21) Appl. No.: 18/529,829

(22) Filed: Dec. 5, 2023

(30) Foreign Application Priority Data
Aug. 24, 2023 (KR) 10-2023-0111093

(51) Int. Cl. H01M 8/04746; H01M 8/04014; H01M 8/04044

(52) U.S. Cl. CPC H01M 8/04768; H01M 8/04014; H01M 8/04044; H01M 2008/1095

(57) ABSTRACT

A cooling structure for an air cooler may include: a stack cooling line through which stack coolant for cooling a fuel cell stack circulates; an electronic component cooling line through which electronic component coolant for cooling an electronic component circulates; an air cooler disposed on the electronic component cooling line to cool air supplied to a cathode of the fuel cell stack; and a first valve connected to the front side of the air cooler to supply at least one of the stack coolant or the electronic component coolant to the air cooler. The cooling structure for an air cooler may include a bypass line connecting the electronic component cooling line upstream of the first valve to the electronic component cooling line downstream of the air cooler in order to allow the electronic component coolant to bypass the air cooler.

### CROSS-REFERENCE TO RELATED APPLICATION

This application claims under 35 U.S.C. § 119 (a) the benefit of priority to Korean Patent Application No. 10-2023-0111093 filed on Aug. 24, 2023, the entire contents of which are incorporated herein by reference.

### BACKGROUND

### (a) Technical Field

The present disclosure relates to a cooling structure for an air cooler capable of preventing increase in ionic conductivity of stack coolant while using at least one of stack coolant or electronic component coolant in order to cool an air cooler for cooling air supplied to a fuel cell stack.

### (b) Background Art

A fuel cell system is a power generation system that generates electrical energy through electrochemical reaction between hydrogen and oxygen using a fuel cell. The fuel cell system is applied to eco-friendly vehicles such as electric vehicles or hybrid vehicles to supply electrical energy required to operate an electric motor.

The fuel cell system includes a fuel cell stack, which is an electricity generating assembly of unit fuel cells. Each includes an air electrode and a fuel electrode, an air supply device configured to supply air to the air electrode of the fuel cell, and a hydrogen supply device configured to supply hydrogen to the fuel electrode of the fuel cell. The air supply device may include an air compressor configured to supply compressed air to the fuel cell stack.

In a polymer fuel cell, a proper amount of moisture is required for an ion-exchange membrane of a membrane-electrode assembly (MEA) to function smoothly, i.e., consistently or efficiently. To this end, the air supply device of the fuel cell system includes a humidifier in order to humidify air supplied to the fuel cell through the air compressor. For example, the humidifier humidifies dry air supplied through the compressor using moisture contained in high-temperature and high-humidity air (wet air) discharged from the air electrode of the fuel cell and supplies the humidified air to the air electrode of the fuel cell.

The air, which may be overheated by the compressor, is introduced into an air cooler in order to be cooled before being supplied to the humidifier. The air cooler requires a refrigerant to cool the overheated air. In general, additionally supplied outside air, electronic component coolant in the fuel cell system, or stack coolant for cooling the fuel cell stack is used to cool the air cooler.

However, the temperature of the electronic component coolant is a temperature that converges to the temperature of outside air. If the air cooler is cooled only using the electronic component coolant in a situation in which the temperature of outside air is low, droplets of water are introduced into the fuel cell stack, leading to deterioration in the durability of the fuel cell stack. In addition, use of the electronic component coolant for cooling of the air cooler causes insufficient cooling of electronic components.

In addition, in a mode in which the output of the fuel cell stack is high, the temperature of the stack coolant is relatively high. Thus, if the air cooler is cooled only using stack coolant, it may be difficult for the air cooler to cool outside air to a desired temperature.

Both the stack coolant and the electronic component coolant may be used to cool the air cooler. In this case, however, because the electronic component coolant has higher ionic conductivity than the stack coolant, the ionic conductivity of the coolant circulating through a stack cooling line increases.

The above information disclosed in this Background section is provided only to enhance understanding of the background of the disclosure. Therefore, the Background section may contain information that does not form the related art that is already known to a person of ordinary skill in the art.

### SUMMARY OF THE DISCLOSURE

The present disclosure has been made in an effort to solve the above-described problems associated with the related art. It is an object of the present disclosure to provide a cooling structure for an air cooler capable of preventing increase in ionic conductivity of stack coolant in a process of using at least one of stack coolant or electronic component coolant in order to cool an air cooler for cooling air supplied to a fuel cell stack.

In one aspect, the present disclosure provides a structure for cooling an air cooler. The structure for cooling an air cooler includes a stack cooling line configured to allow stack coolant for cooling of a fuel cell stack to circulate therethrough, an electronic component cooling line configured to allow electronic component coolant for cooling of an electronic component to circulate therethrough, an air cooler disposed on the electronic component cooling line to cool air supplied to a cathode of the fuel cell stack, and a first valve connected to a front side of the air cooler to supply at least one of the stack coolant or the electronic component coolant to the air cooler. The structure for cooling an air cooler includes a bypass line connecting the electronic component cooling line upstream of the first valve to the electronic component cooling line downstream of the air cooler in order to allow the electronic component coolant to bypass the air cooler.

In one embodiment, the first valve may be disposed on a branch line connecting the air cooler to a front side of the fuel cell stack.

In another embodiment, the air cooler cooling structure may further include a second valve disposed on the bypass line and a third valve disposed on a collection line connecting the air cooler to the stack cooling line downstream of the fuel cell stack.

In still another embodiment, when the output of the fuel cell stack is less than a predetermined output, a first port of the first valve connected to the stack cooling line may be fully opened, a second port of the first valve connected to the electronic component cooling line may be fully closed, and the second valve and the third valve may be opened.

In yet another embodiment, when the output of the fuel cell stack becomes equal to or greater than the predetermined output, the first port of the first valve connected to the stack cooling line may be gradually closed, the second port of the first valve connected to the electronic component cooling line may be gradually opened, and the second valve and the third valve may be gradually closed.

In still yet another embodiment, while the first port of the first valve is fully closed or the second port of the first valve is fully opened, the stack coolant and the electronic component coolant may flow into the air cooler through the first valve.

In a further embodiment, when the output of the fuel cell stack is equal to or greater than the predetermined output, the first port of the first valve connected to the stack cooling line may be fully closed and the second port of the first valve connected to the electronic component cooling line may be fully opened, and the second valve and the third valve may be fully closed in a fully closed state of the first port of the first valve.

In another further embodiment, when the first port of the first valve is fully closed, only the electronic component coolant may flow into the air cooler, and the electronic component coolant having cooled the air cooler may circulate along the electronic component cooling line and may flow into an electronic component radiator disposed on the electronic component cooling line.

In still another further embodiment, the opening angles of the second valve and the third valve may correspond with the opening angle of the first port of the first valve.

In yet another further embodiment, the air cooler cooling structure may further include a controller configured to control the first valve and a flow control valve disposed on the stack cooling line, and the controller may control the first valve and the flow control valve based on the output of the fuel cell stack. When the electronic component coolant and the stack coolant simultaneously flow into the air cooler through the first valve, the controller may control the flow control valve such that coolant circulates to an ion filter disposed on the stack cooling line.

In still yet another further embodiment, when the opening degree of the first port of the first valve connected to the stack cooling line is changed based on the output of the fuel cell stack, the controller may control the flow control valve, based on ionic conductivity of the coolant circulating through the stack cooling line, such that the coolant circulates to the ion filter.

In a still further embodiment, when the first port of the first valve is closed from a fully open state and when the second port of the first valve connected to the electronic component cooling line is closed from a fully open state, the controller may control the flow control valve such that the coolant circulates to the ion filter for a predetermined time period.

In a yet still further embodiment, the predetermined time period may be a time period shorter than a time period taken for the first port of the first valve to be fully closed from a fully open state or a time period taken for the second port of the first valve to be fully closed from a fully open state.

In a yet still further embodiment, the air cooler cooling structure may further include a second valve disposed on the bypass line, and when the first valve is controlled to allow the electronic component coolant flows into the air cooler, the second valve may be opened.

In another aspect, the present disclosure provides a structure for cooling an air. The structure for cooling an air cooler includes a stack cooling line configured to allow stack coolant for cooling of a fuel cell stack to circulate therethrough, an electronic component cooling line configured to allow electronic component coolant for cooling of an electronic component to circulate therethrough, an air cooler disposed on the electronic component cooling line to cool air supplied to a cathode of the fuel cell stack, and a first valve connected to a front side of the air cooler to supply at least one of the stack coolant or the electronic component coolant to the air cooler. The first valve is controlled based on the output of the fuel cell stack. When the first valve is controlled, a flow control valve disposed on the stack cooling line is controlled based on ionic conductivity of the stack coolant such that the stack coolant flows into an ion filter disposed on the stack cooling line.

In an embodiment, the structure for cooling an air cooler may include a bypass line connecting the electronic component cooling line upstream of the first valve to the electronic component cooling line downstream of the air cooler in order to allow the electronic component coolant to bypass the air cooler, and a second valve may be disposed on the bypass line.

In another embodiment, the opening angle of the second valve may correspond with the opening angle of a first port of the first valve connected to the stack cooling line.

In still another embodiment, when the first port of the first valve is closed from a fully open state and when a second port of the first valve connected to the electronic component cooling line is closed from a fully open state, a flow control valve disposed on the stack cooling line may be controlled such that coolant flows into the ion filter for a predetermined time period.

In yet another embodiment, when the output of the fuel cell stack is less than a predetermined output, the first port of the first valve connected to the stack cooling line may be fully opened, and the second port of the first valve connected to the electronic component cooling line may be fully closed.

In still yet another embodiment, when the output of the fuel cell stack is equal to or greater than the predetermined output, the first valve may be controlled such that the first port of the first valve connected to the stack cooling line is fully closed and the second port of the first valve connected to the electronic component cooling line is fully opened.

Other aspects and embodiments of the disclosure are discussed herein.

It should be understood that the terms “vehicle” or “vehicular” or other similar terms as used herein are inclusive of motor vehicles in general. Thus, these terms may encompass passenger automobiles including sport utility vehicles (SUV), buses, trucks, various commercial vehicles, watercraft including a variety of boats and ships, aircraft, and the like. These terms may also include hybrid vehicles, electric vehicles, plug-in hybrid electric vehicles, hydrogen-powered vehicles and other alternative fuel vehicles (e.g., fuels derived from resources other than petroleum). As referred to herein, a hybrid vehicle is a vehicle that has two or more sources of power, for example a vehicle that is both gasoline-powered and electric-powered.

The above and other features of the disclosure are discussed below.

### BRIEF DESCRIPTION OF THE DRAWINGS

The above and other features of the present disclosure are described in detail with reference to certain embodiments thereof illustrated in the accompanying drawings, which are given hereinbelow by way of illustration only, and thus do not limit the present disclosure, and wherein:

FIG. 1 is a diagram showing a cooling structure for an air cooler according to an embodiment of the present disclosure;

FIG. 2 is a block diagram for explaining control strategies of valves according to an embodiment of the present disclosure;

FIGS. 3-5 are diagrams for explaining a control strategy of a first valve according to the output of a fuel cell stack according to an embodiment of the present disclosure;

FIG. 6 is a flowchart showing a method of controlling the cooling structure for an air cooler according to an embodiment of the present disclosure; and

FIG. 7 is a diagram showing a cooling structure for an air cooler according to another embodiment of the present disclosure.

It should be understood that the appended drawings are not necessarily drawn to scale, presenting a somewhat simplified representation of various features illustrative of the basic principles of the disclosure. The specific design features of the present disclosure as disclosed herein, including, for example, specific dimensions, orientations, locations, and shapes, will be determined in part by the particular intended application and use environment.

In the figures, the same reference numbers refer to the same or equivalent parts of the present disclosure throughout the several figures of the drawing.

### DETAILED DESCRIPTION

Advantages and features of the present disclosure and methods for achieving the same should be more clear from embodiments described below in detail with reference to the accompanying drawings. The present disclosure may, however, be embodied in many different forms, and should not be construed as being limited to the embodiments set forth herein. Rather, these embodiments are provided to make this disclosure thorough and complete, and to fully convey the scope of the disclosure to those of ordinary skill in the art. The present disclosure is defined only by the scope of the claims. Throughout the specification, the same reference numerals represent the same components.

The terms “-part”, “-unit”, and “-module” used in the specification mean units for processing at least one function or operation, and can be implemented as hardware components, software components, or combinations of hardware components and software components.

Further, in the following description, the terms “first” and “second” are used only to avoid confusing designated components, and do not indicate the sequence or importance of the components or the relationships between the components. When a component, device, element, or the like of the present disclosure is described as having a purpose or performing an operation, function, or the like, the component, device, or element should be considered herein as being “configured to” meet that purpose or perform that operation or function.

The detailed description is illustrative of the present disclosure. The following description is intended to illustrate and explain the embodiments of the present disclosure and the present disclosure may be used in various other combinations, modifications, and environments. In other words, the present disclosure may be changed or modified within the scope of the inventive concept disclosed herein, the scope of equivalents to the disclosure, and/or the scope of technology or knowledge in the art. The described embodiments illustrate a state for implementing the technical spirit of the present disclosure, and various changes may be made thereto as required for specific applications and uses of the present disclosure. Accordingly, the following detailed description is not intended to limit the present disclosure to the embodiments disclosed herein. Also, the appended claims should be construed as encompassing such other embodiments.

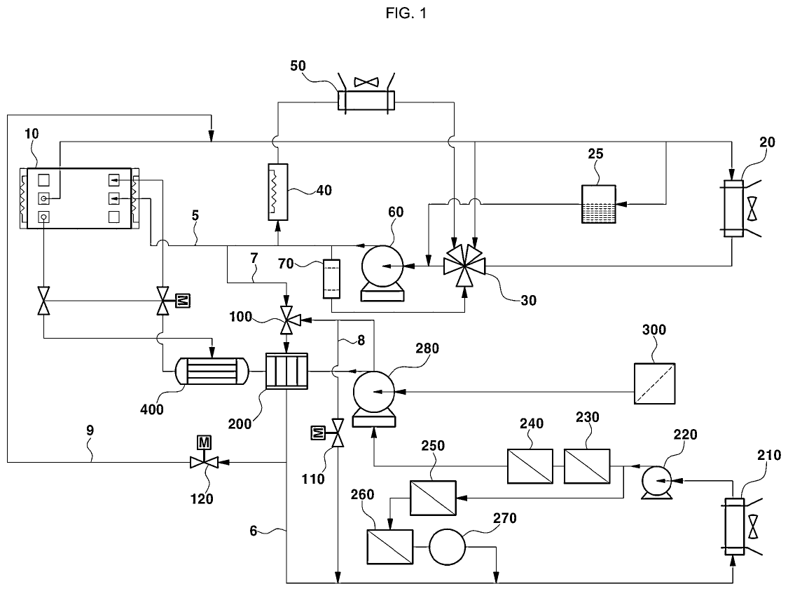

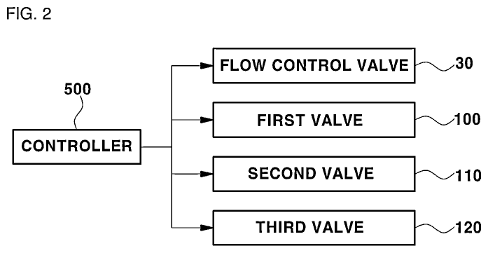

FIG. 1 is a diagram showing a cooling structure for an air cooler according to an embodiment of the present disclosure. FIG. 2 is a block diagram for explaining control strategies of valves according to an embodiment of the present disclosure.

Referring to FIGS. 1 and 2, the cooling structure for an air cooler may be a structure capable of cooling an air cooler 200 for cooling air supplied to a fuel cell stack using any one of coolant circulating through a stack cooling line 5 and coolant circulating through an electronic component cooling line 6. The stack cooling line 5 may be a line through which stack coolant for cooling the fuel cell stack 10 flows. The electronic component cooling line 6 may be a line through which electronic component 10 coolant for cooling electronic components 230, 240, 250, 260, and 270 flows.

The fuel cell stack 10, a radiator 20, a flow control valve 30, a cathode oxygen depletion (COD) heater 40, a heater core 50, a coolant pump 60, and an ion filter 70 may be disposed on the stack cooling line 5.

The fuel cell stack 10 may generate power through chemical reaction between air and hydrogen supplied thereto. The fuel cell stack 10 may be a polymer electrolyte membrane fuel cell (PEMFC) that uses a polymer membrane allowing hydrogen ions to pass therethrough as an electrolyte. In other words, the fuel cell stack 10 may include a polymer electrolyte membrane or a proton exchange membrane (PEM). The power generation efficiency of the fuel cell stack 10 may vary depending on moisture supplied to the polymer electrolyte membrane. The fuel cell stack 10 may include a fuel electrode (anode) and an air electrode (cathode). Reformed hydrogen may be supplied to the fuel electrode of the fuel cell stack 10, and air (oxygen) may be supplied to the air electrode of the fuel cell stack 10. Coolant may be introduced into the fuel cell stack 10 in order to dissipate heat, which is a by-product generated by chemical reaction between hydrogen and oxygen that occurs in the fuel cell stack 10. While the fuel cell stack 10 generates electrical energy through electrochemical reaction between hydrogen and air, high-temperature and high-humidity air may be discharged from the air electrode of the fuel cell stack 10.

The radiator 20 may cool the coolant that has increased in temperature after the chemical reaction in the fuel cell stack 10. The cooled coolant may flow to the flow control valve 30. A reservoir 25 may regulate the pressure of the coolant of the fuel cell thermal management system. The reservoir 25 may suppress the occurrence of cavitation in the coolant pump 60 and may regulate the pressure of the coolant in order to prevent the pressure of the fuel cell stack 10 from exceeding a predetermined inner pressure. Cavitation is a phenomenon in which impulse noise or erosion occurs when bubbles generated in a high-speed and low-pressure part in the coolant pump 60 move to a high-pressure part and disappear. In addition, the reservoir 25 may store the coolant in order to regulate the pressure of the coolant. The reservoir 25 may be disposed downstream of the fuel cell stack 10 and between the fuel cell stack 10 and the front side of the coolant pump 60. The coolant discharged from the fuel cell stack 10 may be stored in the reservoir 25. The coolant discharged from the reservoir 25 may flow into the coolant pump 60. The reservoir 25 may be disposed in parallel with the radiator 20.

The flow control valve 30 may control the path and flow rate of the coolant flowing through the stack cooling line 5. The flow control valve 30 may be a 5-way valve. However, unlike the above-described example, the valve constituting the fuel cell thermal management system may include at least one of a 4-way valve or a 3-way valve. The coolant may flow from the fuel cell stack 10, the radiator 20, the COD heater 40, and the ion filter 70 to the flow control valve 30. The coolant may flow from the flow control valve 30 to the coolant pump 60. The flow control valve 30 may be controlled according to an opening strategy that varies depending on the output of the fuel cell stack 10 or the operation mode of the thermal management system.

The COD heater 40 may consume the power generated by the fuel cell stack 10 in order to increase the temperature of the coolant when increase in the temperature of the coolant is needed or to reduce the voltage of the fuel cell stack 10. In particular, when the fuel cell system is turned on or off and when regenerative braking is continuously performed in the state in which the state of charge (SOC) of a high-voltage battery is sufficient, the COD heater 40 may operate in order to consume the power generated by the fuel cell stack 10.

The heater core 50 may be a component that performs vehicle indoor heating through heat exchange between the coolant that has been increased in temperature by the COD heater 40 and outside air. During indoor heating, the coolant that has been increased in temperature by the COD heater 40 may flow into the heater core 50 to heat the heater core 50, and high-temperature air may flow into the indoor space in the vehicle through heat exchange between the compressed outside air and the heated coolant in the heater core 50.

The coolant pump 60 may supply the coolant delivered from the flow control valve 30 to the fuel cell stack 10, the COD heater 40, or the ion filter 70.

The ion filter 70 may remove ions contained in the coolant. The ion filter 70 may remove ions contained in the coolant provided by the coolant pump 60, and the coolant, with the ions removed therefrom, may be delivered to the flow control valve 30.

An air cooler 200, an electronic component radiator 210, an electronic component coolant pump 220, electronic components 230, 240, 250, 260, and 270, and an air compressor 280 may be disposed on the electronic component cooling line 6.

The air cooler 200 may perform heat exchange between high-temperature air and refrigerant to cool the high-temperature air. In other words, the air cooler 200 may cool air supplied to the cathode of the fuel cell stack 10. The refrigerant may be coolant. In an example, the coolant used as the refrigerant may include at least one of stack coolant for cooling the fuel cell stack 10 or electronic component coolant for cooling the electronic components 230, 240, 250, 260, and 270. The air cooled by the coolant may be supplied to a humidifier 400. The temperature of the air supplied from the air cooler 200 to the humidifier 400 may vary depending on the temperature of the coolant supplied to the air cooler 200.

The electronic component radiator 210 may cool the coolant that has increased in temperature in a process of cooling the electronic components 230, 240, 250, 260, and 270. The coolant cooled by the electronic component radiator 210 may be supplied to the electronic component coolant pump 220. The electronic component coolant pump 220 may supply the cooled coolant to the electronic components 230, 240, 250, 260, and 270.

The electronic components 230, 240, 250, 260, and 270 may include a converter 230, an external power supply unit 240, a power distribution unit 250, an inverter 260, and a motor 270.

The converter 230 may be an integrated DC-DC converter in which a bidirectional high voltage DC-DC converter (BHDC), which is provided between the fuel cell stack 10 and a high-voltage battery mounted in the vehicle, and a low-voltage DC-DC converter (LDC), which converts DC high voltage supplied from the high-voltage battery into DC low voltage, are integrated with each other. The coolant supplied from the electronic component coolant pump 220 may cool the converter 230, and the coolant that has cooled the converter 230 may flow into the external power supply unit 240.

The external power supply unit 240 may include a component (Vehicle to Load (V2L)) that supplies the power of the high-voltage battery mounted in the vehicle to the outside. The coolant that has cooled the external power supply unit 240 may flow into the air compressor 280.

The air compressor 280 may compress outside air and may supply the compressed outside air to the air cooler 200. Outside air may pass through the air filter 300, and may then flow into the air compressor 280, with foreign substances removed therefrom. As the air compressor 280 compresses the air, the pressure and temperature of the air may be increased, and the high-temperature and high-pressure air may be supplied to the air cooler 200.

The power distribution unit (PDU) 250 may be a device that controls power. The coolant supplied from the electronic component coolant pump 220 may cool the power distribution unit 250. The coolant that has cooled the power distribution unit 250 may flow into the inverter 260.

The inverter 260 may be a component that converts current applied or provided to the motor 270, which provides driving force necessary to drive the vehicle. The coolant that has cooled the inverter 260 may flow into the motor 270.

The motor 270 may provide driving force necessary to drive the vehicle. The coolant that has cooled the inverter 260 may cool the motor 270 or an oil cooler that provides oil for cooling of the motor 270. The coolant that has cooled the motor 270 or the oil cooler may flow into the electronic component radiator 210.

The humidifier 400 may humidify the air supplied from the air cooler 200. The humidifier 400 may then supply the humidified air to the cathode (air electrode) of the fuel cell stack 10. For example, the humidifier 400 may be a membrane humidifier, but the disclosure is not limited to any specific type of humidifier 400. The dry air cooled by the air cooler 200 may flow into the fuel cell stack 10 via the humidifier 400.

A first valve 100 for controlling the coolant flowing into the air cooler 200 may be connected to the front (e.g., upstream) side of the fuel cell stack 10. In detail, the first valve 100 may be disposed on a branch line 7 connecting the air cooler 200 to the front side of the fuel cell stack 10. In addition, the first valve 100 may be connected to the electronic component cooling line 6. The coolant that has cooled the air compressor 280 may flow into the first valve 100 before flowing into the air cooler 200. In other words, the first valve 100 may be disposed at the front side (e.g., upstream) of the air cooler 200. For example, the first valve 100 may be a 3-way valve. The first valve 100 may supply at least one of the stack coolant flowing thereinto from the stack cooling line 5 or the electronic component coolant flowing thereinto from the electronic component cooling line 6 to the air cooler 200.

The first valve 100 may include a first port connected to the stack cooling line 5, a second port connected to the electronic component cooling line 6, and a third port discharging the coolant to the air cooler 200. In detail, the stack coolant supplied from the stack cooling line 5 may flow into the first port, and the coolant that has cooled the air compressor 280 may flow into the second port. For example, the opening degrees of the first port and the second port may be regulated by controlling the opening degree of the first valve 100. The third port may always be maintained in an open state. Therefore, the first valve 100 may supply at least one of the stack coolant flowing into the first port or the electronic component coolant flowing into the second port to the air cooler 200.

The structure for cooling an air cooler may include a bypass line 8 for diverting the coolant that has cooled the air compressor 280 to the electronic component radiator 210. The bypass line 8 may be branched from a line between the air compressor 280 and the first valve 100, and may be connected to the rear (e.g., downstream) side of the air cooler 200. The bypass line 8 may connect the electronic component cooling line 6 upstream of the first valve 100 to the electronic component cooling line 6 downstream of the air cooler 200. Therefore, when the second port of the first valve 100 is fully closed, the coolant that has cooled the air compressor 280 may not circulate toward the air cooler 200 but may circulate along the bypass line 8 and flow into the electronic component radiator 210. A second valve 110 may be disposed on the bypass line 8. The second valve 110 may not be an on/off valve but may be a 2-way valve that gradually opens or closes the bypass line 8. Even when the electronic component coolant that has cooled the air compressor 280 is not introduced into the air cooler 200 by the first valve 100, the electronic component coolant may circulate through the bypass line 8. Accordingly, the electronic components 230, 240, 250, 260, and 270 may be continuously cooled.

The coolant discharged from the air cooler 200 may circulate along the electronic component cooling line 6. A collection line 9, which branches from the electronic component cooling line 6, may be connected downstream of the air cooler 200. The collection line 9 may branch from the electronic component cooling line 6 and may be connected to the stack cooling line 5. In detail, the collection line 9 may branch from the electronic component cooling line 6 downstream of the air cooler 200 and may be connected to the stack cooling line 5 downstream of the fuel cell stack 10.

The coolant circulating through the collection line 9 may be the stack coolant or a mixture of the stack coolant and the electronic component coolant. Thus, the stack coolant and the electronic component coolant may be coolants composed of the same ingredients. The coolant circulating through the collection line 9 may flow into the stack cooling line 5 downstream of the fuel cell stack 10 and may then flow into the radiator 20. A third valve 120 may be disposed on the collection line 9. The third valve 120 may not be an on/off valve but may be a 2-way valve that gradually opens or closes the collection line 9. When only the electronic component coolant flows into the air cooler 200, the third valve 120 is closed, thereby preventing inflow of the electronic component coolant into the stack cooling line 5 to the maximum extent.

A controller 500 may control the flow control valve 30, the first valve 100, the second valve 110, and the third valve 120 based on the output of the fuel cell stack 10 and the ionic conductivity of the coolant circulating through the stack cooling line 5. The opening angles or degree of the second valve 110 and the third valve 120 may correspond to the opening angle or degree of the first port of the first valve 100. In other words, when the first port of the first valve 100 is in a fully open state, the second valve 110 and the third valve 120 may be in a fully open state, and when the first port of the first valve 100 is in a fully closed state, the second valve 110 and the third valve 120 may be in a fully closed state. In addition, as the first port of the first valve 100 is gradually closed, the second valve 110 and the third valve 120 may be closed to the same degree as the first port of the first valve 100, and as the first port of the first valve 100 is gradually opened, the second valve 110 and the third valve 120 may be opened to the same degree as the first port of the first valve 100.

The controller 500 may control the first valve 100 based on whether the output of the fuel cell stack 10 is equal to or greater than a predetermined output. The fuel cell thermal management system may control the flow path of the coolant differently depending on a normal output mode or a high output mode of the fuel cell stack 10. The predetermined output may be a reference, based on whether the fuel cell stack 10 is in the high output mode is determined. When the output of the fuel cell stack 10 is equal to or greater than the predetermined output, maximum cooling of the air cooler 200 is required, and the controller 500 may control the first valve 100 to allow the electronic component coolant to flow into the air cooler 200. When the output of the fuel cell stack 10 is less than the predetermined output, if the electronic component coolant, which has relatively low temperature, flows into the air cooler 200, the air supplied to the fuel cell stack 10 may be supercooled. Accordingly, droplets may be introduced into the fuel cell stack 10, thus deteriorating the durability of the fuel cell stack 10. Therefore, in order to prevent supercooling of the air cooler 200, the controller 500 may control the first valve 100 such that only the stack coolant flows into the air cooler 200.

The controller 500 may measure the ionic conductivity of the coolant circulating through the stack cooling line 5 when both the electronic component coolant and the stack coolant flow into the air cooler 200. When both the electronic component coolant and the stack coolant flow into the air cooler 200, the electronic component coolant may flow into the stack cooling line 5 through the collection line 9. The electronic component coolant may have higher ionic conductivity than the stack coolant. Thus, as the electronic component coolant flows into the stack cooling line 5, there may occur a problem in which the ionic conductivity of the coolant circulating through the stack cooling line 5 increases. Therefore, the controller 500 may control the flow control valve 30 based on the ionic conductivity such that the coolant flows into the ion filter 70. The electronic component coolant may flow into the stack cooling line 5 when the fuel cell stack 10 is in the high output mode. When the fuel cell stack 10 is in the high output mode, the controller 500 may control the flow control valve 30 to temporarily allow the coolant to flow into the ion filter 70.

According to an aspect of the present disclosure, since the temperature of the coolant supplied to the air cooler 200 by the first valve 100 is controlled over a wide range, the temperature of the air supplied from the air cooler 200 to the humidifier 400 may be controlled over a wide range. Accordingly, the temperature of the air supplied to the humidifier 400 may be actively controlled, whereby the humidification performance of the humidifier 400 may be improved.

According to an aspect of the present disclosure, stable performance of the fuel cell stack 10 may be ensured, and durability thereof may be improved by preventing the temperature of the air flowing into the fuel cell stack 10 from excessively decreasing or increasing.

According to an aspect of the present disclosure, in the normal mode, the stack coolant, which has relatively high temperature, may be used to regulate the temperature of the air cooler 200 in order to prevent inflow of droplets into the fuel cell stack 10. In the high output mode, the electronic component coolant, which has relatively low temperature, may be used in order to achieve maximum cooling of the air cooler 200.

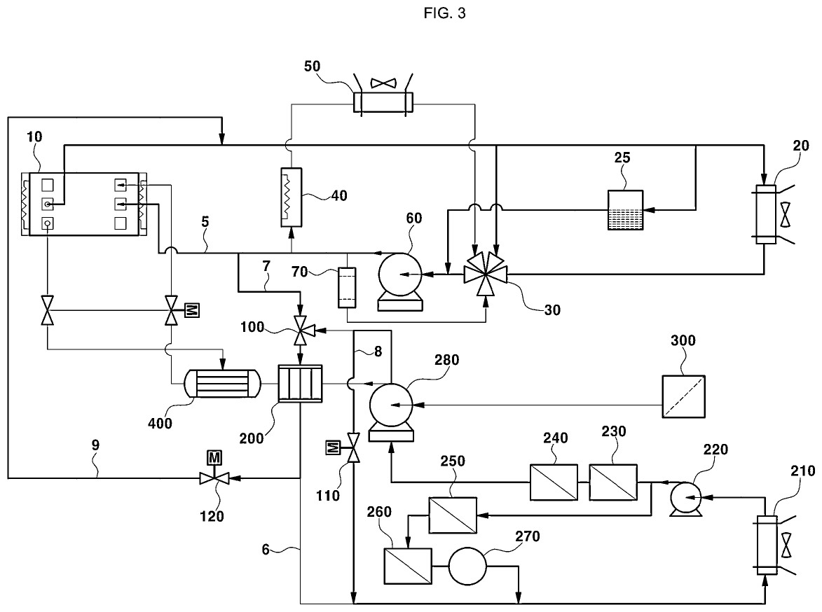

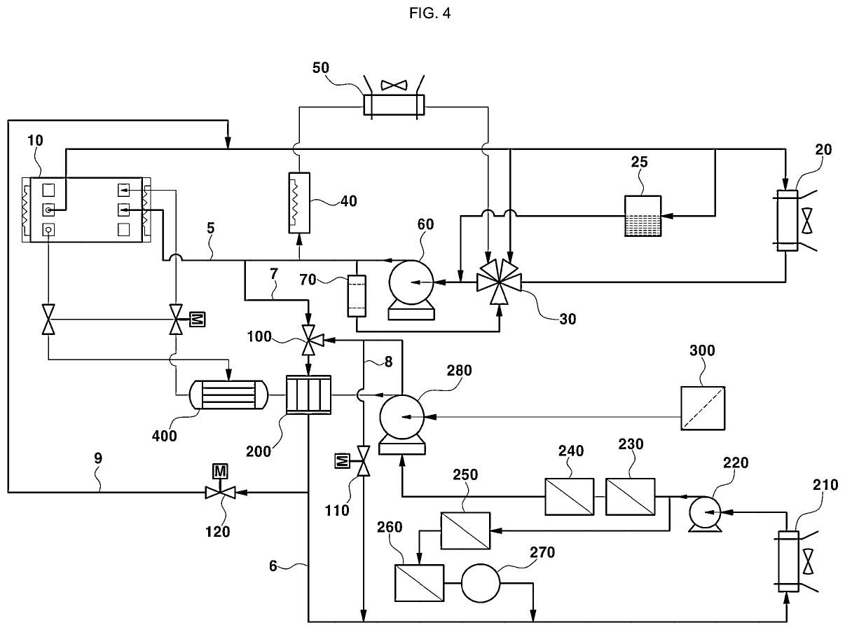

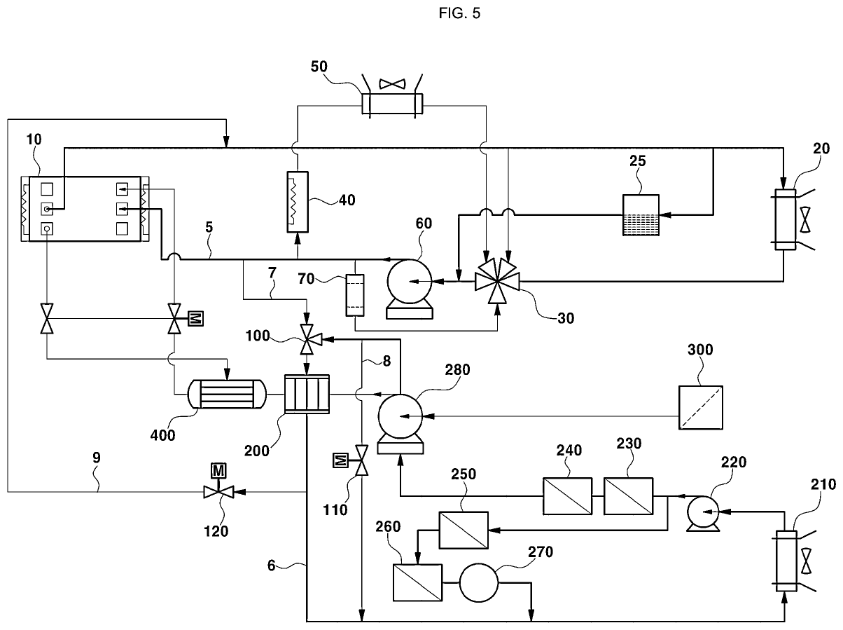

FIGS. 3-5 are diagrams for explaining a control strategy of the first valve according to the output of the fuel cell stack according to an embodiment of the present disclosure. FIG. 3 is a diagram showing a situation in which only the stack coolant is introduced into the air cooler by the first valve when the output of the fuel cell stack is less than the predetermined output. FIG. 4 is a diagram showing a situation in which both the stack coolant and the electronic component coolant are introduced into the air cooler by the first valve when the output of the fuel cell stack is equal to or greater than the predetermined output. FIG. 5 is a diagram showing a situation in which only the electronic component coolant is introduced into the air cooler by the first valve when the output of the fuel cell stack is equal to or greater than the predetermined output.

Referring to FIGS. 2 and 3, when the output of the fuel cell stack 10 is less than the predetermined output, the controller 500 may fully open the first port of the first valve 100 connected to the stack cooling line 5. When the vehicle is in a normal driving situation, the output of the fuel cell stack 10 is less than the predetermined output. In this case, the first port of the first valve 100 may be maintained in an open state. In addition, the second port of the first valve 100, which is connected to the electronic component cooling line 6, may be in a fully closed state, and the second valve 110 and the third valve 120 may be in a fully open state in order to correspond to the first port of the first valve 100. Therefore, only the stack coolant may be supplied to the air cooler 200, and the stack coolant that has cooled the air cooler 200 may circulate to the stack cooling line 5 through the collection line 9. The electronic component coolant that has cooled the electronic components 230, 240, 250, 260, and 270 may circulate along the bypass line 8 and may flow into the electronic component radiator 210. Since the electronic component coolant does not flow into the stack cooling line 5, the controller 500 may not need to control the flow control valve 30 to allow the coolant to flow into the ion filter 70.

Referring to FIGS. 2 and 4, when the output of the fuel cell stack 10 is equal to or greater than the predetermined output, the controller 500 may control the first valve 100 such that the first port of the first valve 100, which is connected to the stack cooling line 5, is fully closed. In this case, the first port of the first valve 100 may be gradually closed, and the second port of the first valve 100 may be gradually opened. The second valve 110 and the third valve 120 may be gradually closed in the same manner as the opening strategy of the first port of the first valve 100.

As the first port of the first valve 100, the second valve 110, and the third valve 120 are gradually closed, both the stack coolant and the electronic component coolant may flow into the air cooler 200. The stack coolant may flow into the first port of the first valve 100 through the branch line 9 and may flow into the air cooler 200 through the opened first port of the first valve 100. The electronic component coolant that has cooled the air compressor 280 may flow into the second port of the first valve 100 and may flow into the air cooler 200 through the second port of the first valve 100. As the second valve 110 is gradually closed, the coolant that has cooled the air cooler 200 may be discharged to the collection line 9 and the electronic component cooling line 6. In addition, as the third valve 120 is gradually closed, the electronic component coolant may also circulate through the bypass line 8. When both the stack coolant and the electronic component coolant flow into the air cooler 200, the third valve 120 is also in a partially open state, and thus the electronic component coolant flows into the stack cooling line 5. In this case, the controller 500 may control the flow control valve 30 such that the coolant circulating through the stack cooling line 5 flows into the ion filter 70, thereby appropriately controlling the ionic conductivity of the coolant.

As the electronic component coolant flows into the stack cooling line 5 through the collection line 9, the ionic conductivity of the coolant circulating through the stack cooling line 5 may increase. The controller 500 may control the flow control valve 30, based on the ionic conductivity of the coolant acquired from an ionic conductivity sensor, such that the coolant flows into the ion filter 70. When the opening degree of the first valve 100 is changed, the controller 500 may control the flow control valve 30, based on the ionic conductivity of the coolant circulating through the stack cooling line 5, such that the coolant circulates to the ion filter 70. The case in which the opening degree of the first valve 100 is changed may correspond to a case in which the first port of the first valve 100 is closed from a fully open state and a case in which the second port of the first valve 100 is closed from a fully open state. In other words, when the first port of the first valve 100 is maintained in a fully open state and when the first port of the first valve 100 is maintained in a fully closed state, the controller 500 may determine that there is no need to remove ions contained in the coolant circulating through the stack cooling line 5. In addition, when the opening degree of the first valve 100 is changed, if the ionic conductivity is less than a threshold value, the controller 500 may not control the flow control valve 30 to allow the coolant to circulate to the ion filter 70. When the opening degree of the first valve 100 is changed and when the ionic conductivity is equal to or greater than the threshold value, the controller 500 may control the flow control valve 30 such that the coolant circulates to the ion filter 70. In this case, the controller 500 may control the flow control valve 30 such that the coolant circulates to the ion filter 70 for a predetermined time period. The predetermined time period may be defined as a time period shorter than a time period taken for the first port of the first valve 100 to be fully closed from a fully open state or a time period taken for the second port of the first valve 100 to be fully closed from a fully open state. However, the predetermined time period may be a time period that may be changed by a designer.

Referring to FIGS. 2 and 5, when the output of the fuel cell stack 10 is equal to or greater than the predetermined output, the opening degree of the first valve 100 may be gradually changed such that the first port of the first valve 100 is fully closed and the second port of the first valve 100 is fully opened. In this case, the second valve 110 and the third valve 120 may be fully closed in the same manner as the opening strategy of the first port of the first valve 100. Therefore, only the low-temperature electronic component coolant that has cooled the air compressor 280 may flow into the air cooler 200, and the stack coolant may not flow into the air cooler 200. Since the third valve 120 is in a fully closed state, the electronic component coolant that has cooled the air compressor 280 may circulate only to the air cooler 200. Since the first valve 110 is in a fully closed state, the electronic component coolant that has cooled the air cooler 200 may circulate along the electronic component cooling line 6.

While the first port of the first valve 100 is maintained in a fully closed state, the controller 500 may determine that there is no need to allow the coolant to flow into the ion filter 70. Since the second valve 110 is in a fully closed state, the electronic component coolant may not flow into the stack cooling line 5 through the collection line 9. Since there is no possibility for the coolant circulating through the stack cooling line 5 to be increased in ionic conductivity by inflow of the electronic component coolant, the controller 500 may not control the flow control valve 30.

Unlike the above-described example, the flow control valve 30 may be controlled according to the control strategy of the fuel cell thermal management system. An aspect of the present disclosure illustrates that the first valve 100 and the flow control valve 30 are controlled based on the output of the fuel cell stack 10 and the ionic conductivity of the coolant circulating through the stack cooling line 5.

According to an aspect of the present disclosure, when the electronic component coolant flows into the stack cooling line 5, the controller 500 may control the flow control valve 30 to allow the coolant to circulate to the ion filter 70, thereby preventing increase in the ionic conductivity of the coolant circulating through the stack cooling line 5.

According to an aspect of the present disclosure, under the condition that cooling performance of the air cooler 200 needs to be ensured due to the high output mode of the fuel cell stack 10, only the electronic component coolant that has cooled the air compressor 280 flows into the air cooler 200 through the first valve 110, thereby cooling the air cooler 200 to the maximum extent.

According to an aspect of the present disclosure, the coolant discharged from the air cooler 200 circulates along the electronic component cooling line 6, and inflow of the electronic component coolant into the stack cooling line 5 through the collection line 9 branching from the electronic component cooling line 6 and the second valve 120 disposed on the collection line 9 may be prevented to the maximum extent.

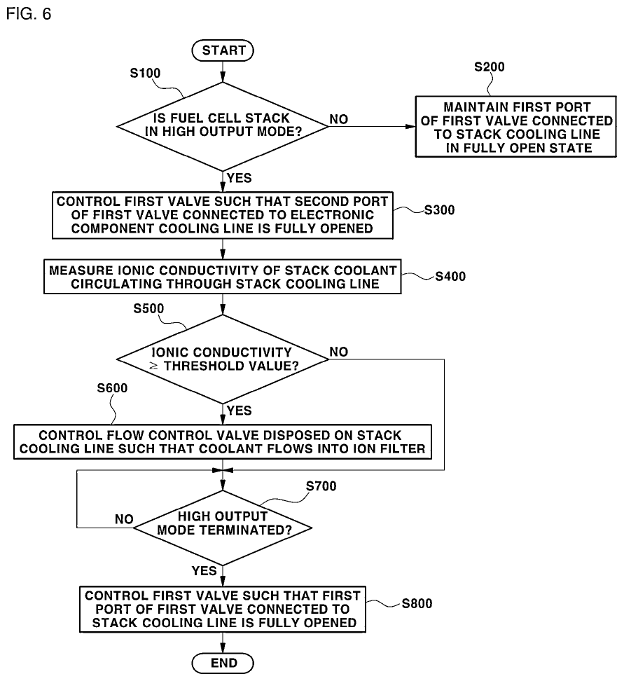

FIG. 6 is a flowchart showing a method of controlling the air cooler cooling structure according to an embodiment of the present disclosure.

Referring to FIGS. 1, 2, and 6, the controller 500 may monitor whether the fuel cell stack 10 is operated in the high output mode. When the fuel cell stack 10 is operated in the high output mode, the temperature of the stack coolant circulating through the stack cooling line 5 may be very high. When the high-temperature stack coolant is used to cool the air cooler 200, it may be difficult for the air cooler 200 to lower the temperature of air supplied to the fuel cell stack 10 to a desired temperature due to relatively low cooling efficiency (S100).

When the fuel cell stack 10 is in the normal mode rather than the high output mode, the temperature of the stack coolant circulating through the stack cooling line 5 may be lower than the temperature of the stack coolant when the fuel cell stack 10 is in the high output mode. Therefore, even when the air cooler 200 is cooled using the stack coolant, the air supplied to the fuel cell stack 10 may be cooled to a desired temperature. The controller 500 may maintain the first port of the first valve 100, which is connected to the stack cooling line 5, in a fully open state. Since the first port of the first valve 100 is maintained in a fully open state, the second valve 110 and the third valve 120 may also be maintained in a fully open state (S200).

When the fuel cell stack 10 is in the high output mode, the controller 500 may control the first valve 100 such that the second port of the first valve 100, which is connected to the electronic component cooling line 6, is fully opened so that the electronic component coolant, which has relatively low temperature, flows into the air cooler 200. As the second port of the first valve 100 is gradually opened, the second valve 110 and the third valve 120 may be gradually closed (S300).

When the opening degree of the first valve 100 is changed, the controller 500 may measure the ionic conductivity of the coolant circulating through the stack cooling line 5. The ionic conductivity may be monitored at all times by the ionic conductivity sensor disposed on the stack cooling line 5 (S400).

When the ionic conductivity of the coolant circulating through the stack cooling line 5 is less than the threshold value, even if the opening degree of the first valve 100 is changed, the coolant circulating through the stack cooling line 5 may not flow into the ion filter 70. When the ionic conductivity is less than the threshold value, the coolant may not flow into the ion filter 70 in order to ensure the durability of the ion filter 70 (S500).

When the ionic conductivity of the coolant circulating through the stack cooling line 5 is equal to or greater than the threshold value, the controller 500 may control the flow control valve 30 such that the coolant flows into the ion filter 70. The flow control valve 30 may be a valve that is capable of changing the path of the coolant to the ion filter 70. The controller 500 may control the flow control valve 30 such that the coolant flows into the ion filter 70 only for a predetermined time period (S600).

The controller 500 may continuously monitor the output of the fuel cell stack 10. When the high output mode of the fuel cell stack 10 is not terminated, the second port of the first valve 100 may be maintained in a fully open state. Since the state in which the second port of the first valve 100 is maintained in a fully open state is a state in which there is no change in the opening degree of the first valve 100, the controller 500 may control the flow control valve 30 such that the coolant circulating through the stack cooling line 5 does not flow into the ion filter 70. While the second port of the first valve 100 is controlled to be fully opened from a fully closed state, the coolant circulating through the stack cooling line 5 may pass through the ion filter 70. Therefore, while the second port of the first valve 100 is maintained in a fully open state, there may be no need to remove ions contained in the coolant circulating through the stack cooling line 5 (S700).

When the high output mode of the fuel cell stack 10 is terminated, the controller 500 may control the first valve 100 such that the first port of the first valve 100, which is connected to the stack cooling line 5, is fully opened. While controlling the first port of the first valve 100 to be fully opened, the controller 500 may monitor the ionic conductivity of the coolant circulating through the stack cooling line 5. When the ionic conductivity of the coolant circulating through the stack cooling line 5 becomes equal to or greater than the threshold value before the first port of the first valve 100 is fully opened, the controller 500 may control the flow control valve 30 in order to remove ions contained in the coolant circulating through the stack cooling line 5 (S800).

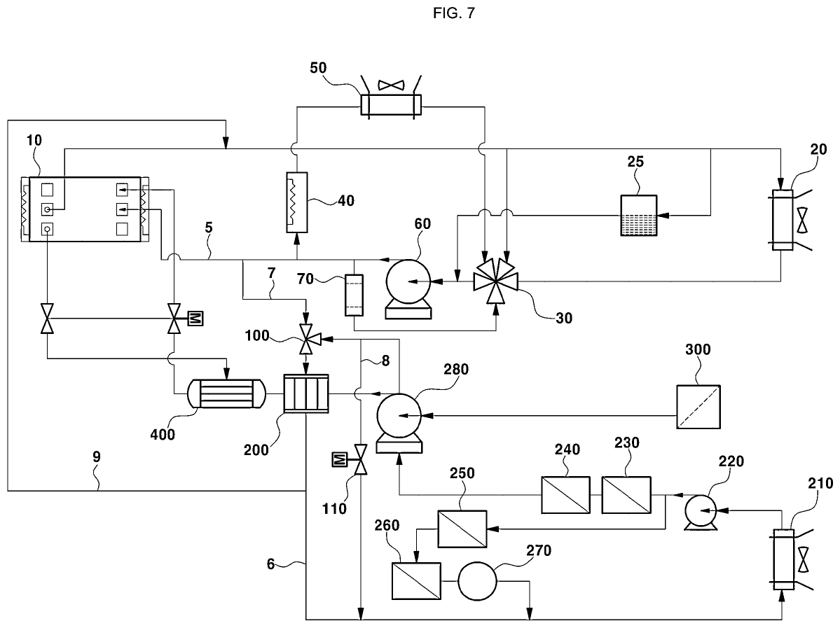

FIG. 7 is a diagram showing an air cooler cooling structure according to another embodiment of the present disclosure. For simplicity of explanation, a redundant description of the same configuration as that shown in FIG. 1 is omitted.

Referring to FIG. 7, no separate valve may be disposed on the collection line 9. The stack coolant circulating through the stack cooling line 5 and the electronic component coolant circulating through the electronic component cooling line 6 may be coolants composed of the same ingredients.

When the first port of the first valve 100 is fully opened and the second valve 110 is fully opened, only the stack coolant may flow into the air cooler 200. The stack coolant that has cooled the air cooler 200 may flow into the stack cooling line 5 through the collection line 9.

When the first port of the first valve 100 is partially opened and the second valve 110 is partially opened, the stack coolant and the electronic component coolant may flow into the air cooler 200. The stack coolant and the electronic component coolant that have cooled the air cooler 200 may be mixed, a mixture thereof may circulate through the electronic component cooling line 6, and a portion of the mixture may flow into the stack cooling line 5 through the collection line 9. When the electronic component coolant flows into the stack cooling line 5 and thus the ionic conductivity of the coolant circulating through the stack cooling line 5 becomes equal to or higher than a threshold value, the controller controlling the first valve 100 may control the flow control valve 30 such that the coolant flows into the ion filter 70.

When the first port of the first valve 100 is fully closed and the second valve 110 is fully closed, the electronic component coolant may flow into the air cooler 200. The electronic component coolant that has cooled the air cooler 200 may circulate through the electronic component cooling line 6, and a portion thereof may flow into the stack cooling line 5 through the collection line 9. The case in which the first port of the first valve 100 is fully closed and the second valve 110 is fully closed corresponds to a case in which the fuel cell stack 10 is in the high output mode. It is common for the fuel cell stack 10 to be maintained in the high output mode for a short period of time. Therefore, when the first port of the first valve 100 is fully closed and the second valve 110 is fully closed, the controller may control the flow control valve 30 such that the coolant flows into the ion filter 70, thereby preventing increase in the ionic conductivity of the coolant circulating through the stack cooling line 5.

According to an embodiment of the present disclosure, even when the collection line 9, which circulates the coolant discharged from the air cooler 200 to the stack cooling line 5, is always kept open, increase in the ionic conductivity of the coolant circulating through the stack cooling line 5 may be prevented by controlling the flow control valve 30. Because no valve is provided in the collection line 9, a situation in which the electronic component coolant flows into the stack cooling line 5 may occur relatively frequently. However, the controller may temporarily control the flow control valve 30 such that the coolant circulating through the stack cooling line 5 flows into the ion filter 70, thereby preventing increase in the ionic conductivity of the coolant circulating through the stack cooling line 5.

As should be apparent from the above description, according to an aspect of the present disclosure, since the temperature of coolant supplied to an air cooler by a three-way valve is controlled over a wide range, the temperature of air supplied from the air cooler to a humidifier may be controlled over a wide range. Accordingly, the temperature of the air supplied to the humidifier may be actively controlled, whereby the humidification performance of the humidifier may be improved.

According to an aspect of the present disclosure, stable performance of a fuel cell stack may be ensured and durability thereof may be improved by preventing the temperature of air flowing into the fuel cell stack from excessively decreasing or increasing.

According to an aspect of the present disclosure, in a normal mode, stack coolant, which has relatively high temperature, may be used to regulate the temperature of the air cooler in order to prevent inflow of droplets into the fuel cell stack. In a high output mode, electronic component coolant, which has relatively low temperature, may be used in order to achieve maximum cooling of the air cooler.

According to an aspect of the present disclosure, when the electronic component coolant flows into a stack cooling line, a controller may control a flow control valve to allow the coolant to circulate to an ion filter, thereby preventing increase in the ionic conductivity of the coolant circulating through the stack cooling line.

According to an aspect of the present disclosure, under the condition that cooling performance of the air cooler needs to be ensured due to the high output mode of the fuel cell stack, only the electronic component coolant that has cooled an air compressor flows into the air cooler through a first valve, thereby cooling the air cooler to the maximum extent.

According to an aspect of the present disclosure, the coolant discharged from the air cooler circulates along an electronic component cooling line, and inflow of the electronic component coolant into the stack cooling line through a collection line branching from the electronic component cooling line and a second valve disposed on the collection line may be prevented to the maximum extent.

The present disclosure has been described above with reference to several embodiments. The embodiments described in the specification and shown in the accompanying drawings are illustrative only and are not intended to represent all aspects of the disclosure. Therefore, the present disclosure is not limited to the embodiments presented herein, and it is to be understood by those of ordinary skill in the art that various modifications or changes may be made without departing from the technical spirit or essential characteristics of the disclosure as disclosed in the appended claims.

What is claimed is:

1. A structure for cooling an air cooler, the structure comprising:
a stack cooling line configured to allow stack coolant for cooling a fuel cell stack to circulate therethrough;
an electronic component cooling line configured to allow electronic component coolant for cooling an electronic component to circulate therethrough;
an air cooler disposed on the electronic component cooling line to cool air supplied to a cathode of the fuel cell stack;
a first valve connected to a front side of the air cooler to supply at least one of the stack coolant or the electronic component coolant to the air cooler; and
a bypass line connecting the electronic component cooling line upstream of the first valve to the electronic component cooling line downstream of the air cooler in order to allow the electronic component coolant to bypass the air cooler.

2. The structure of claim 1, wherein the first valve is disposed on a branch line connecting the air cooler to a front side of the fuel cell stack.

3. The structure of claim 1, further comprising:
a second valve disposed on the bypass line; and
a third valve disposed on a collection line connecting the air cooler to the stack cooling line downstream of the fuel cell stack.

4. The structure of claim 3, wherein, when an output of the fuel cell stack is less than a predetermined output, a first port of the first valve connected to the stack cooling line is fully opened, a second port of the first valve connected to the electronic component cooling line is fully closed, and the second valve and the third valve are opened.

5. The structure of claim 4, wherein, when the output of the fuel cell stack becomes equal to or greater than the predetermined output, the first port of the first valve connected to the stack cooling line is gradually closed, the second port of the first valve connected to the electronic component cooling line is gradually opened, and the second valve and the third valve are gradually closed.

6. The structure of claim 5, wherein, while the first port of the first valve is fully closed or the second port of the first valve is fully opened, the stack coolant and the electronic component coolant flow into the air cooler through the first valve.

7. The structure of claim 3, wherein, when an output of the fuel cell stack is equal to or greater than a predetermined output, a first port of the first valve connected to the stack cooling line is fully closed and a second port of the first valve connected to the electronic component cooling line is fully opened, and the second valve and the third valve are fully closed in a fully closed state of the first port of the first valve.

8. The structure of claim 7, wherein:
when the first port of the first valve is fully closed, only the electronic component coolant flows into the air cooler; and
the electronic component coolant having cooled the air cooler circulates along the electronic component cooling line and flows into an electronic component radiator disposed on the electronic component cooling line.

9. The structure of claim 3, wherein opening angles of the second valve and the third valve correspond with an opening angle of a first port of the first valve.

10. The structure of claim 1, further comprising a controller configured to control the first valve and a flow control valve disposed on the stack cooling line,
wherein the controller controls the first valve and the flow control valve based on an output of the fuel cell stack, and
wherein, when the electronic component coolant and the stack coolant simultaneously flow into the air cooler through the first valve, the controller controls the flow control valve such that coolant circulates to an ion filter disposed on the stack cooling line.

11. The structure of claim 10, wherein, when an opening degree of a first port of the first valve connected to the stack cooling line is changed based on the output of the fuel cell stack, the controller controls the flow control valve, based on ionic conductivity of the coolant circulating through the stack cooling line, such that the coolant circulates to the ion filter.

12. The structure of claim 11, wherein, when the first port of the first valve is closed from a fully open state and when a second port of the first valve connected to the electronic component cooling line is closed from a fully open state, the controller controls the flow control valve such that the coolant circulates to the ion filter for a predetermined time period.

13. The structure of claim 12, wherein the predetermined time period is a time period shorter than a time period taken for the first port of the first valve to be fully closed from a fully open state or a time period taken for the second port of the first valve to be fully closed from a fully open state.

14. The structure of claim 1, further comprising a second valve disposed on the bypass line,
wherein when the first valve is controlled to allow the electronic component coolant flows into the air cooler, the second valve is opened.

15. A structure for cooling an air cooler, the structure comprising:
a stack cooling line configured to allow stack coolant for cooling a fuel cell stack to circulate therethrough;
an electronic component cooling line configured to allow electronic component coolant for cooling an electronic component to circulate therethrough;
an air cooler disposed on the electronic component cooling line to cool air supplied to a cathode of the fuel cell stack; and
a first valve connected to the air cooler to supply at least one of the stack coolant or the electronic component coolant to the air cooler,
wherein the first valve is controlled based on an output of the fuel cell stack, and
wherein, when the first valve is controlled, a flow control valve disposed on the stack cooling line is controlled based on ionic conductivity of the stack coolant such that the stack coolant flows into an ion filter disposed on the stack cooling line.

16. The structure of claim 15, further comprising:
a bypass line connecting the electronic component cooling line upstream of the first valve to the electronic component cooling line downstream of the air cooler in order to allow the electronic component coolant to bypass the air cooler,
wherein a second valve is disposed on the bypass line.

17. The structure of claim 16, wherein an opening angle of the second valve corresponds with an opening angle of a first port of the first valve connected to the stack cooling line.

18. The structure of claim 17, wherein, when the first port of the first valve is closed from a fully open state and when a second port of the first valve connected to the electronic component cooling line is closed from a fully open state, a flow control valve disposed on the stack cooling line is controlled such that coolant flows into the ion filter for a predetermined time period.

19. The structure of claim 15, wherein, when the output of the fuel cell stack is less than a predetermined output, a first port of the first valve connected to the stack cooling line is fully opened, and a second port of the first valve connected to the electronic component cooling line is fully closed.

20. The structure of claim 15, wherein, when the output of the fuel cell stack is equal to or greater than a predetermined output, the first valve is controlled such that a first port of the first valve connected to the stack cooling line is fully closed and a second port of the first valve connected to the electronic component cooling line is fully opened.
